(19) United States
(12) Patent Application Publication
(10) Pub. No.: US 2004/0233052 A1
(43) Pub. Date: Nov. 25, 2004

(54) Browser apparatus

(75) Inventors: Yuichiro Uchigaki, Tokyo (JP); Shizuka Maegaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/826,255

(22) Filed: Apr. 19, 2004

(30) Foreign Application Priority Data
May 20, 2003 (JP) 2003-142298

(51) Int. Cl. G06F 17/00; G08B 25/00

(52) U.S. Cl. 340/525

(57) ABSTRACT

A browser apparatus includes an information acquisition section for acquiring homepage data, a display section for displaying information, a shift direction input section for inputting a shift direction, a command input section for inputting a command, and a control section for displaying the homepage data acquired by the information acquisition section on the display section in response to a shift command indicating the shift direction input by the shift direction input section and the operation command indicating the operation input by the command input section. The control section has a plurality of operation modes, and assigns different functions to the shift direction input section and command input section in each of the operation modes as the functions of manipulating the homepage displayed on the display section. The browser apparatus is superior in operability, enabling the easy manipulation of a displayed window.

### BACKGROUND OF THE INVENTION

1. Field of the Invention

The present invention relates to a browser apparatus for looking through homepages, and particularly to a technique for improving the operability of manipulating the browser with a limited number of buttons.

2. Description of Related Art

A browser installed in a personal computer or the like is configured such that it is manipulated with a pointing device, typified by a mouse, and a keyboard. For example, page scrolling is carried out by grabbing a scroll bar at the right-hand side and/or bottom of a window, and by moving the mouse in the vertical or horizontal direction. In addition, to call for an action linked to an anchor displayed in a page, the mouse cursor is placed on the anchor, followed by clicking.

Recently, a browser has been introduced into a vehicle-mounted apparatus such as a car navigation system to make an access to the Internet by manipulating the browser with a remote control. However, the remote control of the vehicle-mounted apparatus usually includes only a small number of buttons, and hence it is difficult for a user to operate the browser in the same manner as manipulating a personal computer.

As a related technique, Relevant Reference 1 discloses an information processing system that enables a user to carry out input operation with a single input device instead of a keyboard and mouse, thereby enabling the connection to the Internet easily and quickly. The information processing system, which has an analog controller connected to a personal computer, enables the key input by pointing a key on the keyboard displayed on a CRT with a keyboard pointer key and by clicking a click button instead of using a conventional keyboard, and enables the mouse operation by manipulating a mouse pointer key and the click button. The scrolling across a window on the CRT is carried out with a scrolling key and the click button, and the window is maximized, minimized or closed by manipulating dedicated buttons. The change of the character size is carried out with a character size switching button, and the TAB manipulation is carried out with a TAB button.

Another Relevant Reference 2 discloses a WWW browser apparatus capable of selecting an anchor tag or a form easily in a television set or word processor without a pointing device such as a mouse. In the WWW browser apparatus, an HTML text reader reads the HTML text designated by default. An HTML analyzer analyzes the HTML text, generates display data, and determines a display area on a display for displaying the display data. A code assignor provides a mark number to the character string of an anchor tag in the display area of the display data. A controller displays the display data to which the mark number is assigned on the display.

Relevant Reference 1: Japanese patent application laid-open No. 2000-181605.

Relevant Reference 2: Japanese patent application laid-open No. 11-25114/1999.

The conventional browsers in the car navigation system are configured as described above. Accordingly, providing them with a lot of buttons corresponding to the number of functions will be able to improve the operability of the browsers. However, this configuration will provide a hew problem of complicating the manipulation because the user must select an intended button from among many buttons. In particular, as for the vehicle-mounted apparatus, simple manipulation is required from the viewpoint of safety.

### SUMMARY OF THE INVENTION

The present invention is implemented to solve the foregoing problem. It is therefore an object of the present invention to provide a browser apparatus with superior operability capable of manipulating the displayed window with ease.

According to an aspect of the present invention, there is provided a browser apparatus comprising: information acquisition means for acquiring homepage data; display means for displaying information; shift direction input means for inputting a shift direction; command input means for inputting a command; and control means for displaying the homepage data acquired by the information acquisition means on the display means in response to a shift command indicating a shift direction input by the shift direction input means and to an operation command indicating an operation input by the command input means, wherein the control means has a plurality of operation modes, and assigns different functions to the shift direction input means and the command input means in each of the plurality of operation modes as functions of manipulating the homepage displayed on the display means.

According to the present invention, the browser apparatus has a plurality of operation modes, and assigns different functions to the shift direction input means and command input means in each of the operation modes as the functions of manipulating the homepage displayed on the display means. Thus, a user can manipulate the homepage with ease by changing the operation mode to that suitable for manipulating the homepage. As a result, it offers an advantage of being able to provide the browser apparatus that is superior in operability and enables the user to manipulate the displayed window easily.

### BRIEF DESCRIPTION OF THE DRAWINGS

FIG. 1 is a block diagram showing a hardware configuration of an embodiment 1 of the browser apparatus in accordance with the present invention;

FIG. 2 is a functional block diagram showing a functional configuration of the embodiment 1 of the browser apparatus in accordance with the present invention;

FIG. 3 is a table illustrating relationships between operation modes and remote control manipulations provided by the embodiment 1 of the browser apparatus in accordance with the present invention;

FIG. 4 is a flowchart (1) illustrating the operation of the embodiment 1 of the browser apparatus in accordance with the present invention;

FIG. 5 is a flowchart (2) illustrating the operation of the embodiment 1 of the browser apparatus in accordance with the present invention;

FIG. 6 is a flowchart (3) illustrating the operation of the embodiment 1 of the browser apparatus in accordance with the present invention; and

FIG. 7 is a schematic diagram illustrating windows for explaining the operation of the embodiment 1 of the browser apparatus in accordance with the present invention.

### DETAILED DESCRIPTION OF THE PREFERRED EMBODIMENT

The embodiment in accordance with the present invention will now be described with reference to the accompanying drawings. The following description is made by way of example in which the browser apparatus in accordance with the present invention is applied to a vehicle-mounted navigation system.

### Embodiment 1

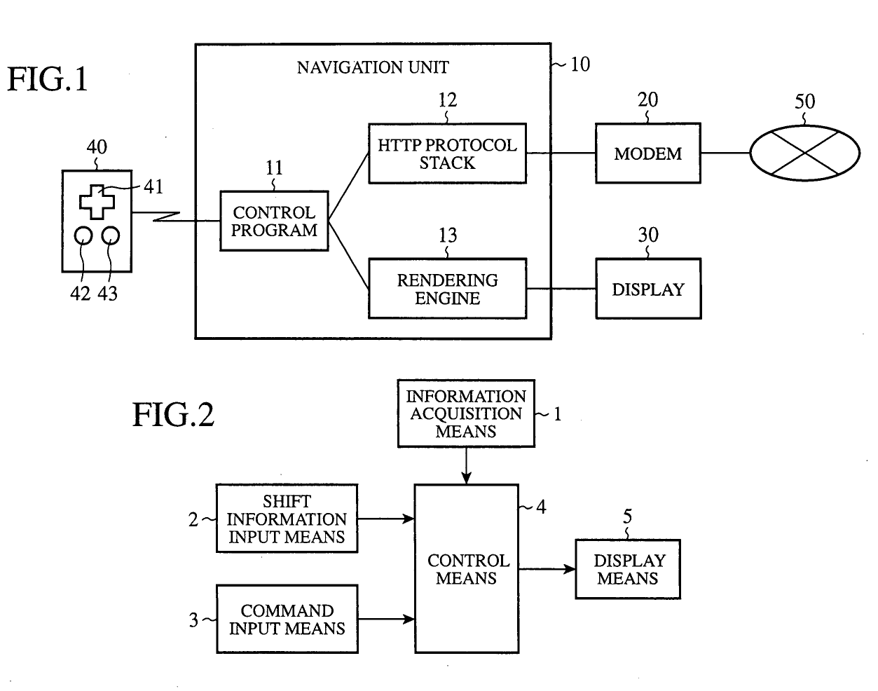

FIG. 1 is a block diagram showing a hardware configuration of an embodiment 1 of the browser apparatus in accordance with the present invention. The browser apparatus comprises a vehicle-mounted navigation unit 10, a modem 20, a display 30 and a remote control 40.

The navigation unit 10 comprises a microcomputer, and includes a control program 11, an HTTP protocol stack 12 and a rendering engine 13. The control program 11 executed by the microcomputer implements browser functions. The processing of the control program 11 will be described in more detail later with reference to flowcharts. The HTTP protocol stack 12 stacks the TCP protocol to control the data transfer between the control program 11 and the modem 20. The rendering engine 13 generates image data to be displayed on the basis of the display data sent from the program 11, and supplies the image data to the display 30.

The modem 20 modulates the data from the HTTP protocol stack 12 to be transmitted to the Internet 50, and demodulates the data received from the Internet 50 to be transferred to the HTTP protocol stack 12.

The display 30, which is composed of a liquid crystal display (LCD), for example, displays a map, route, destination, current position and traveling direction of the vehicle and so forth necessary for implementing the navigation functions. The display 30 also displays the image of a homepage to implement the browser functions.

The remote control 40 carries out infrared communication with the navigation unit 10 to transmit various commands to the control program 11. The remote control 40 has a cross key 41, an enter key 42 and a back key 43.

The cross key 41, which is depressible in four directions, top, bottom, left and right directions, generates four types of signals in response to the depression directions. The generated signal is converted to an infrared signal to be sent to the navigation unit 10 as a shift command. As for the cross key 41, the portion to be depressed in the top direction is called a top key, the portion to be depressed in the bottom direction a bottom key, the portion to be depressed to the left a left key, and the portion to be depressed to the right a right key in the following description for the sake of convenience.

The enter key 42 is mainly used for confirming the input operation. The signal generated by depressing the enter key 42 is converted to the infrared signal to be sent to the navigation unit 10 as the operation command.

The back key 43 is mainly used for causing transition of the operation mode. The signal generated by depressing the back key 43 is converted to the infrared signal to be sent to the navigation unit 10 as the operation command. Receiving the infrared signal from the remote control 40, the navigation unit 10 converts the infrared signal to an electrical signal to be transmitted to the control program 11 as a shift command or operation command.

The browser apparatus with the foregoing configuration has three operation modes associate with the manipulation of the browser: a menu mode, a surf mode and a scrolling mode. The current operation mode is stored in an internal memory of the navigation unit 10 as a flag so that the control program 11 can decide the current operation mode by the flag. The operation mode is initially set at the menu mode.

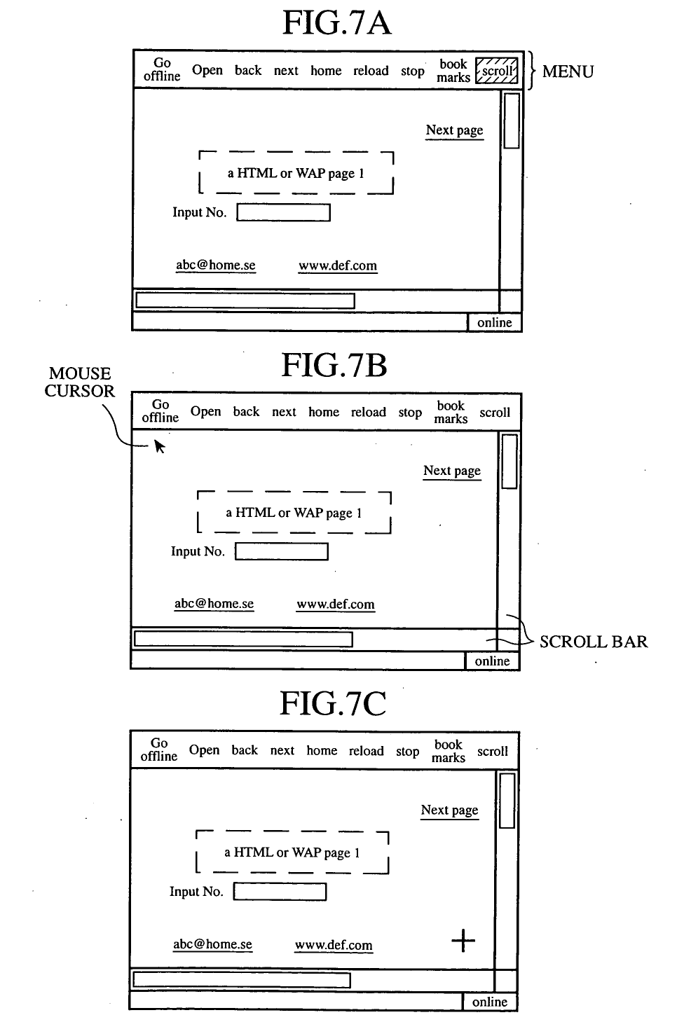

The menu mode is one of the operation modes for a user to select the menu displayed in a window of the display 30 (see FIG. 7). The surf mode is one of the operation modes for the user to move the mouse cursor displayed in the window of the display 30 in the same manner as operating the mouse on an ordinary personal computer. The scrolling mode is one of the operation modes for the user to move the entire page displayed in the window of the display 30.

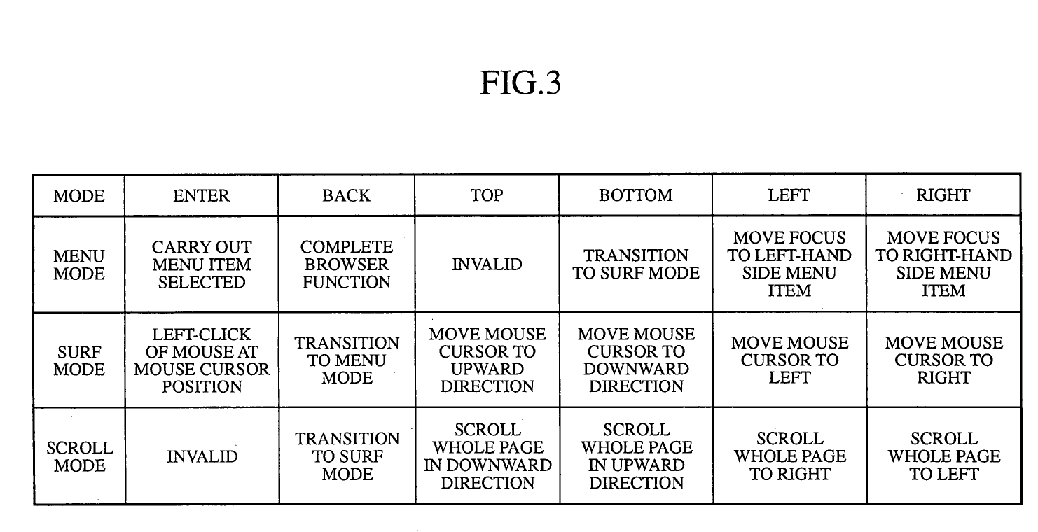

The functions assigned to the cross key 41, enter key 42 and back key 43 of the remote control 40 vary according to the operation modes. In the menu mode, the enter key 42 is used to perform the menu item selected from the menu displayed on the display 30 as shown in FIG. 3. The back key 43 is used for closing the browser. The top key of the cross key 41 is not used (its depression is made invalid). The bottom key is used to instruct the transition to the surf mode. The left key is used to shift the focus to the left-hand side menu item. The right key is used to shift the focus to the right-hand side menu item.

In the surf mode, the enter key 42 is used to cause the same operation as clicking the mouse at a mouse cursor position displayed in the window of the display 30 in the same manner as placing the mouse cursor on an anchor in the window displayed on the personal computer and then clicking the mouse. The back key 43 is used to shift the operation mode back to the menu mode. The top key of the cross key 41 is used to move the mouse cursor in the upward direction. The bottom key is used to move the mouse cursor in the downward direction. The left key is used to move the mouse cursor to the left. The right key is used to move the mouse cursor to the right.

In the scrolling mode, the enter key 42 is not used (its depression is made invalid). The back key 43 is used to shift the operation mode back to the surf mode. The top key of the cross key 41 is used to move the entire page displayed in the window of the display 30 in the upward direction. The bottom key is used to move the entire page in the downward direction. The left key is used to move the entire page to the left, and the right key is used to move the entire page to the right.

FIG. 2 is a functional block diagram showing the functions of the browser apparatus with the foregoing hardware configuration. The individual functional blocks are implemented by the foregoing hardware in conjunction with the processing of the control program 11. The browser apparatus functionally includes an information acquisition means 1, a shift information input means 2, a command input means 3, a control means 4 and a display means 5 as shown in FIG. 2.

The information acquisition means 1, which corresponds to the HTTP protocol stack 12 and modem 20 of the navigation unit 10, downloads homepage data from a site connected to the Internet 50. The homepage data acquired by the information acquisition means 1 is transferred to the control means 4.

The shift information input means 2, which corresponds to the cross key 41 of the remote control 40, transfers the shift command input by the manipulation of the cross key 41 to the control means 4.

The command input means 3, which corresponds to the enter key 42 and back key 43 of the remote control 40, transfers the operation commands generated by the manipulation of the enter key 42 and back key 43 to the control means 4.

The control means 4, which corresponds to the control program 11 of the navigation unit 10, processes the homepage data acquired by the information acquisition means 1 in response to the shift command from the shift information input means 2 and the operation command from the command input means 3, and transfers the processing results to the display means 5 as the display data.

The display means 5, which corresponds to the rendering engine 13 and display 30, displays the image in accordance with the display data transferred from the control means 4.

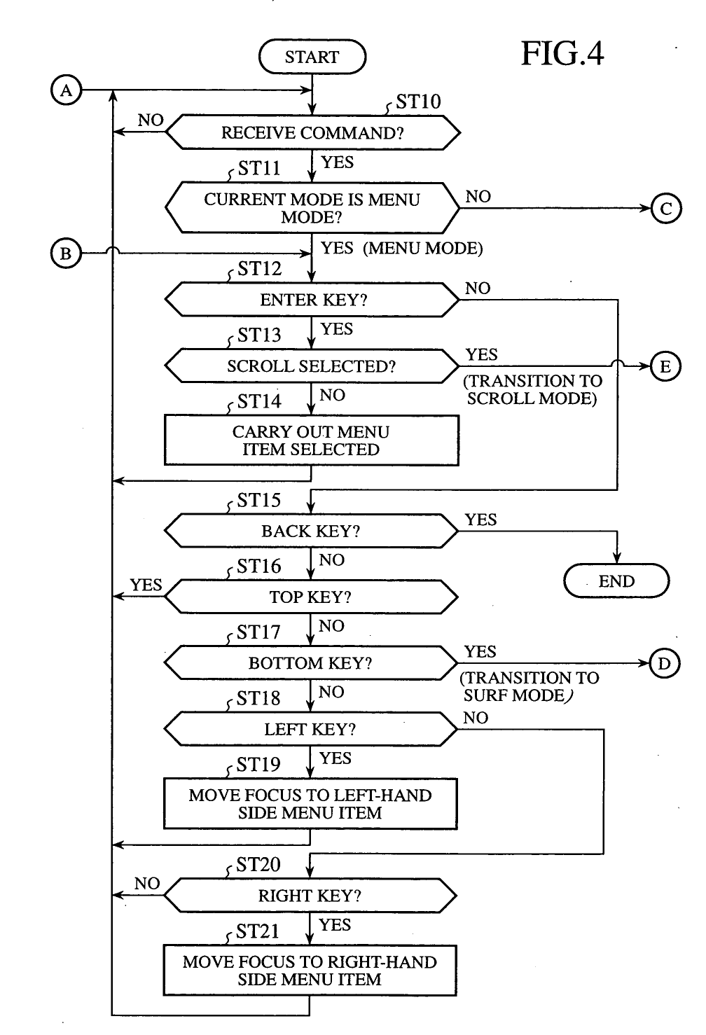

Next, the operation of the embodiment 1 of the browser apparatus in accordance with the present invention will be described with reference to the flowcharts of FIGS. 4-6 and examples of the windows of FIG. 7 with focusing on the processing of the control program 11 in the navigation unit 10.

First, as illustrated in FIG. 4, the control program 11 of the browser apparatus checks as to whether the command (shift command or operation command) is received from the remote control 40 or not (step ST10). If it decides that no command is received, it makes a loop at step ST10 to wait receiving the command, thereby entering a standby state. If it decides that the command is received in the standby state, the control program 11 makes a decision as to whether the current operation mode is the menu mode or not (step ST11).

If the control program 11 decides that the current mode is the menu mode at step ST11, it carries out the processing of the menu mode from step ST12 to ST21. FIG. 7(A) illustrates an example of the initial window of the menu mode. In the menu mode, the control program 11 checks as to whether the enter key 42 is depressed or not (step ST12). If it makes a decision that the enter key 42 is depressed, the control program 11 checks as to whether the scrolling of the menu item is selected, that is, whether it is focused (step ST13). If the control program 11 makes a decision that the scrolling is selected, the sequence branches to step ST34 to make transition to the scrolling mode processing.

If the control program 11 makes a decision that the scrolling is not selected at step ST13, it carries out the menu item selected at that time (one of Go offline, Open, back, next, home, reload, stop and book marks) (step ST14). Subsequently, it returns the sequence to step ST10.

If the control program 11 makes a decision that the enter key 42 is not depressed at step ST12, it checks as to whether the back key 43 is depressed or not (step ST15). If it makes a decision that the back key 43 is depressed, the control program 11 closes the processing for implementing the browser function. After that, it carries out the processing for implementing the navigation function (not shown), for example.

If the control program 11 makes a decision that the back key 43 is not depressed at step ST15, it checks as to whether the top key of the cross key 41 is depressed or not (step ST16). If it makes a decision that the top key is depressed, it returns the sequence to step ST10. Thus, the function is achieved of invalidating the manipulation of the top key in the menu mode.

If the control program 11 makes a decision that the top key is not depressed at step ST16, it then checks as to whether the bottom key is depressed or not (step ST17). If it makes a decision that the bottom key is depressed, the sequence branches to step ST23 to shift to the surf mode processing.

If the control program 11 makes a decision that the bottom key is not depressed at step ST17, it then checks as to whether the left key is depressed or not (step ST18). If it makes a decision that the left key is depressed, the control program 11 shifts the focus to the menu item at the left-hand side (step ST19). After that, it returns the sequence to step ST10.

If the control program 11 makes a decision that the left key is not depressed at step ST18, it checks as to whether the right key is depressed or not (step ST20). If it makes a decision that the right key is depressed, the control program 11 shifts the focus to the menu item at the right-hand side (step ST21). After that, it returns the sequence to step ST10.

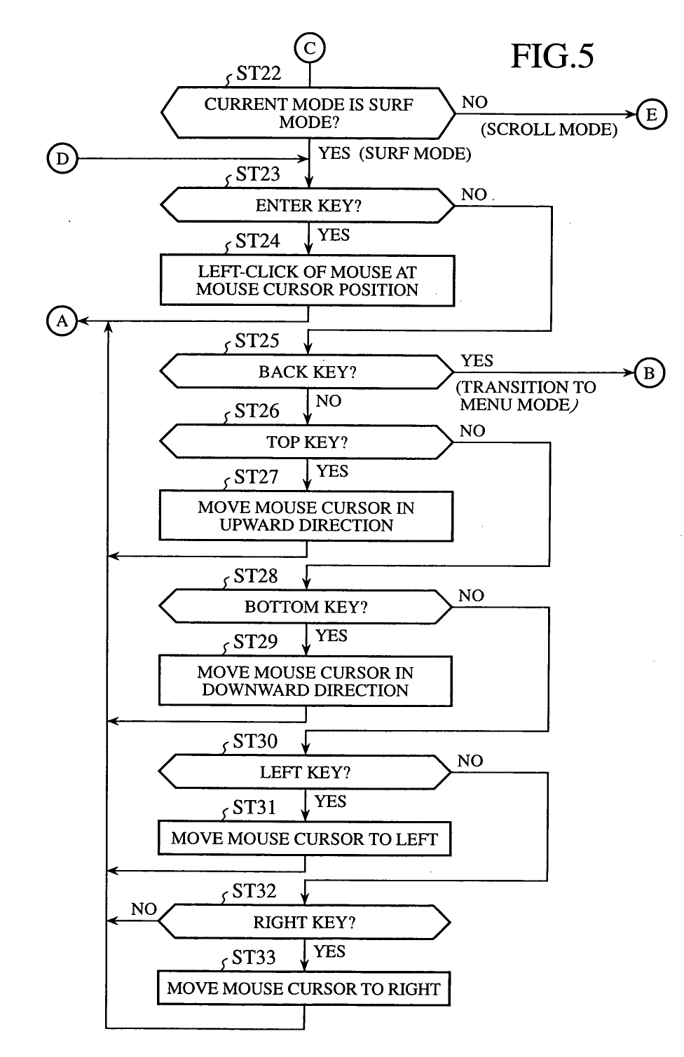

If the control program 11 makes a decision that the current operation mode is not the menu mode at step ST11, it checks as to whether the current operation mode is the surf mode or not at FIG. 5 (step ST22). If it makes a decision that the current mode is the surf mode at step ST22, the control program 11 carries out the processing of the surf mode from step ST23 to ST33. FIG. 7(B) shows an example of the initial window of the surf mode, which is characterized in that the mouse cursor is displayed on the window.

In the surf mode processing, the control program 11 checks as to whether the enter key 42 is depressed or not (step ST23), first. If it makes a decision that the enter key 42 is depressed, the control program 11 carries out the same processing as that when the mouse is left-clicked at the mouse cursor position on the window of the ordinary personal computer (step ST24). Thus, when the mouse cursor points an anchor, the action linked to the anchor is called for. Otherwise, the manipulation of the enter key 42 is ignored. After that, it returns the sequence to step ST10.

If the control program 11 makes a decision that the enter key 42 is not depressed at step ST23, it checks as to whether the back key 43 is depressed or not (step ST25). If it makes a decision that the back key 43 is depressed, the sequence branches to step ST12 to make transition to the menu mode processing.

If the control program 11 makes a decision that the back key 43 is not depressed at step ST25, it then checks as to whether the top key of the cross key 41 is depressed or not (step ST26). If it makes a decision that the top key is depressed, the control program 11 carries out the processing of moving the mouse cursor in the upward direction (step ST27). After that, it returns the sequence to step ST10.

If the control program 11 makes a decision that the top key is not depressed at step ST26, it checks as to whether the bottom key is depressed or not (step ST28). If it makes a decision that the bottom key is depressed, the control program 11 carries out the processing of moving the mouse cursor in the downward direction (step ST29). After that, it returns the sequence to step ST10.

If the control program 11 makes a decision that the bottom key is not depressed at step ST28, it checks as to whether the left key is depressed or not (step ST30). If it makes a decision that the left key is depressed, the control program 11 carries out the processing of moving the mouse cursor to the left (step ST31). After that, it returns the sequence to step ST10.

If the control program 11 makes a decision that the left key is not depressed at step ST30, it then checks as to whether the right key is depressed or not (step ST32). If it makes a decision that the right key is depressed, the control program 11 carries out the processing of moving the mouse cursor to the right (step ST33). After that, it returns the sequence to step ST10.

If the control program 11 makes a decision that the current operation mode is not the surf mode at step ST22, it recognizes that the current mode is the scrolling mode, and carries out the processing of the scrolling mode from step ST34 to ST43. FIG. 7(C) shows an example of the initial window of the scrolling mode, which is characterized in that the “+” mark representing the scrolling mode is displayed in the window.

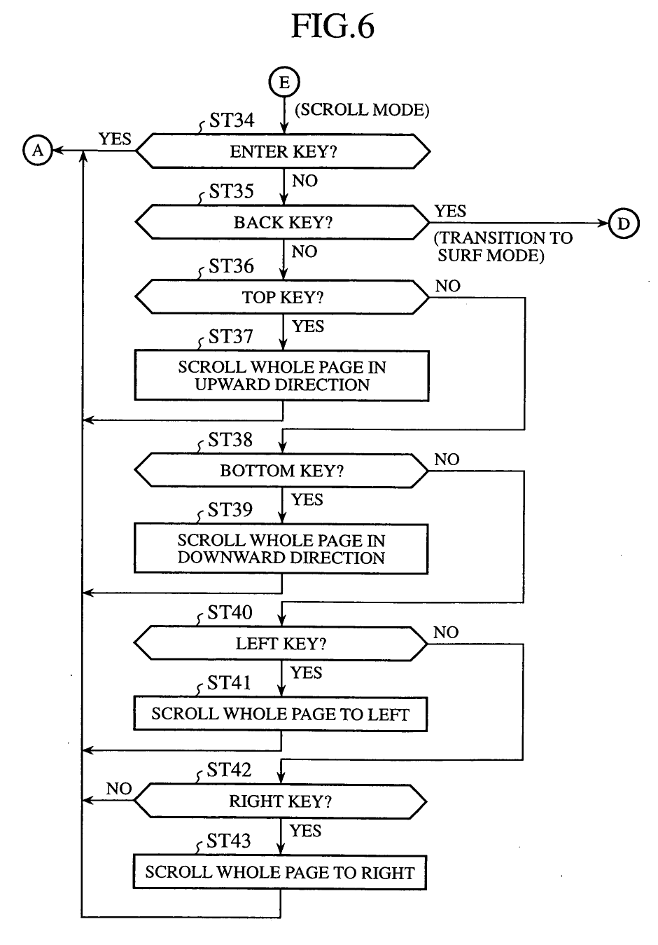

In the scrolling mode processing, the control program 11 checks as to whether the enter key 42 is depressed or not as illustrated in FIG. 6 (step ST34), first. If it makes a decision that the enter key 42 is depressed, it returns the sequence to step ST10, thereby invalidating the manipulation of the enter key 42 in the scrolling mode.

If the control program 11 makes a decision that the enter key 42 is not depressed at step ST34, it checks as to whether the back key 43 is depressed or not (step ST35). If it makes a decision that the back key 43 is depressed, the sequence branches to step ST23 to make transition to the surf mode processing.

If the control program 11 makes a decision that the back key 43 is not depressed at step ST35, it then checks as to whether the top key of the cross key 41 is depressed or not (step ST36). If it makes a decision that the top key is depressed, the control program 11 carries out the processing of scrolling the entire page in the upward direction (step ST37). After that, it returns the sequence to step ST10.

If the control program 11 makes a decision that the top key is not depressed at step ST36, it then checks as to whether the bottom key is depressed or not (step ST38). If it makes a decision that the bottom key is depressed, the control program 11 carries out the processing of scrolling the entire page in the downward direction (step ST39) After that, it returns the sequence to step ST10.

If the control program 11 makes a decision that the bottom key is not depressed at step ST38, it then checks as to whether the left key is depressed or not (step ST40). If it makes a decision that the left key is depressed, the control program 11 carries out the processing of scrolling the entire page to the left (step ST41). After that, it returns the sequence to step ST10.

If the control program 11 makes a decision that the left key is not depressed at step ST40, it then checks as to whether the right key is depressed or not (step ST42). If it makes a decision that the right key is depressed, the control program 11 carries out the processing of scrolling the entire page to the right (step ST43) After that, it returns the sequence to step ST10.

Next, to deepen understanding of the present invention, an example will be described of the transition between the windows of the display 30 of the browser apparatus by the foregoing processing.

FIG. 7(A) shows a menu mode window. In this state, in which the window is displayed, the focus of the menu item (Go offline, Open, back, next, home, reload, stop, book marks and scrolling) can be shifted to the left-hand side by depressing the left key of the cross key 41. FIG. 7(A) illustrates the state in which the focus is placed on the scrolling. In contrast, the focus of the menu item can be shifted to the right-hand side by depressing the right key. By depressing the right key successively, the focus of the menu item shifts to the right-hand side step by step. In the menu mode, placing the focus on the menu item, followed by depressing the enter key 42, causes the menu item to be carried out. In this way, the browser functions can be switched.

When the bottom key of the cross key 41 is depressed in the menu mode, the browser apparatus shifts the mode to the surf mode. In the surf mode, the mouse cursor is displayed on the window as illustrated in FIG. 7(B). In the state, in which the window is displayed, the mouse cursor can be moved to the leftmost or rightmost edge by manipulating cross key 41 in the same manner as manipulating the mouse on the ordinary personal computer. In addition, depressing the enter key 42 can bring about the same operation as when the mouse is left-clicked at the mouse cursor position in the window of the ordinary personal computer. Therefore pointing the anchor by the mouse cursor, followed by depressing the enter key 42 can call for the action linked to the anchor. In addition, moving the mouse pointer at the position of the scroll bar, followed by depressing the enter key 42, can move the entire page displayed in the window. Furthermore, depressing the back key 43 in the surf mode can shift the operation mode to the menu mode.

Placing the focus on the “scrolling” by manipulating the cross key 41 in the menu mode, and then depressing the enter key 42 makes it possible for the browser apparatus to shift its mode to the scrolling mode. In the scrolling mode the “+” mark is displayed in the window as illustrated in FIG. 7(C). Manipulating the cross key 41 in the state, in which the window is displayed, can move the entire page to the leftmost or rightmost edge. Depressing the back key 43 enables the operation mode to shift to the surf mode. The depression of the enter key 42 is made invalid in this mode.

As described above, the embodiment 1 of the browser apparatus in accordance with the present invention has the three operation modes, the menu mode, surf mode and scrolling mode, and assigns different functions to the cross key 41, enter key 42 and back key 43 of the remote control 40 in the individual operation modes, thereby enabling a variety of manipulations with a small number of keys. In other words, operating the browser by switching the operation mode enables the easy manipulation of the browser with the device such as the remote control of the car navigation system including only two buttons like the enter key 42 and back key 43, and the cross key 41.

In addition, the user can switch the browser functions in the menu mode, can select the anchor in the same feeling as manipulating the browser with the mouse on the ordinary personal computer in the surf mode, and can read the entire page quickly instead of selecting the anchor in the scrolling mode. Therefore the user can manipulate the browser easily and quickly by switching the operation mode appropriately.

What is claimed is:

1. A browser apparatus comprising:
information acquisition means for acquiring homepage data;
display means for displaying information;
shift direction input means for inputting a shift direction;
command input means for inputting a command; and
control means for displaying the homepage data acquired by said information acquisition means on said display means in response to a shift command indicating a shift direction input by said shift direction input means and to an operation command indicating an operation input by said command input means, wherein
said control means has a plurality of operation modes, and assigns different functions to said shift direction input means and said command input means in each of the plurality of operation modes as functions of manipulating the homepage displayed on said display means.

2. The browser apparatus according to claim 1, wherein said control means switches the plurality of operation modes in response to the shift command from said shift direction input means or to the operation command from said command input means.

3. The browser apparatus according to claim 2, wherein the plurality of operation modes includes:
a menu mode of selecting a menu item from a menu displayed on said display means in response to the shift command from said shift direction input means;
a surf mode of selecting part of the homepage by moving a mouse cursor displayed on said display means in response to the shift command from said shift direction input means; and
a scrolling mode of scrolling the homepage displayed on said display means in vertical and horizontal directions in response to the shift command from said shift direction input means.

4. The browser apparatus according to claim 2, wherein said shift direction input means comprises a cross key for outputting four types of shift commands by manipulating the cross key in four directions, top, bottom, left and right directions.

5. The browser apparatus according to claim 2, wherein said command input means comprises an enter key for starting processing, and a back key for making transition of the operation mode.
